(19) United States
(12) Patent Application Publication
(10) Pub. No.: US 2016/0263703 A1
(43) Pub. Date: Sep. 15, 2016

(54) Laser Welded Foil-fin Heat-Exchanger

(71) Applicant: MAKAI OCEAN ENGINEERING, INC., Kailua, HI (US)

(72) Inventors: Michael P. ELDRED, Kailua-Kona, HI (US); Robert G. LOUDON, Kailua-Kona, HI (US); Adam N. LANDHERR, Stewartville, MN (US); Eli N. Michael, Kailua-kona, HI (US)

(21) Appl. No.: 15/066,046

(22) Filed: Mar. 10, 2016

Related U.S. Application Data
(60) Provisional application No. 62/132,584, filed on Mar. 13, 2015.

(51) Int. Cl. B23K 26/323; B23K 26/21; F28F 19/00; F28D 9/00; F28F 3/02

(52) U.S. Cl. CPC B23K 26/323; F28D 9/0025; F28F 3/02; F28F 19/00; B23K 26/21

(57) ABSTRACT

Various embodiments include a plate-fin type heat exchanger constructed from foil-fin layers of corrugated fins sandwiched between two sheets of thin metal plate or foil. The corrugated fins are laser welded to the metal sheets, creating continuous joints along the length of fin crests formed in the sheets by the corrugated fins. Foil-fin layers in a stack are separated by spacers or header bars to create adjacent flow paths to finned chambers with walls defined by outside faces of adjacent bonded plate-fin layers. The foil plates and the corrugated fins may be of similar or dissimilar metals. Embodiments include methods of manufacturing such heat exchangers including applying a vacuum to an assembly of corrugated fins sandwiched between sheets of thin metal plate or foil, causing fin crests in the sheets, mapping locations of the fin crests, and using the map to perform high speed laser welding along the fin crests.

### RELATED APPLICATIONS

This application claims the benefit of priority to U.S. Provisional Application 62/132,584 entitled “Bonded Foil-fin Heat-Exchanger” filed Mar. 13, 2015, the entire contents of which are hereby incorporated by reference.

### TECHNICAL FIELD

The various embodiments relate to the field of heat exchanges and heat exchanger component engineering, and more specifically to a new structural design and manufacturing process for plate-fin and compact fin heat exchangers.

### BACKGROUND

In order to economically exploit the temperature differences in the tropical ocean to produce renewable energy and commercially exploit the Ocean Thermal Energy Conversion (OTEC) plants improved heat exchangers are required. OTEC imposes unique needs upon heat exchangers that are not generally present in other commercial heat exchanger applications. The important characteristics for an OTEC heat exchanger are low seawater side head losses, excellent thermal performance when operating with a small temperature difference, and superior corrosion resistance in warm surface seawater and cold deep seawater to enable an economically viable operating life. The small overall temperature difference between the hot and cold sources for such power plants means very large heat exchanger surfaces are necessary. Therefore, small improvements in OTEC heat exchanger performance, cost or life may have large impacts in the economic viability of this technology.

### SUMMARY

Various embodiments include a heat exchange structure that may make use of dissimilar metals to provide corrosion resistant heat exchangers with reduced dependence on high priced metals, and thus, provide lower fabrication costs. Various embodiments provide a new structure and new construction method that results in a higher heat exchange performance and greater flow orientation flexibility than with conventional elements of a plate-fin heat exchanger. The heat exchangers according to various embodiments are particularly well suited to address the needs of OTEC applications, but are well suited for many marine applications and industries requiring heat exchanges compatible with at least one corrosive fluid.

Various embodiments may include a plate-fin type heat-exchanger formed from a number of foil-fin layers. In various embodiments, the foil-fin layers may be constructed of corrugated fins sandwiched between two sheets of thin metal plate or foil. The corrugated fins may be laser welded to the metal sheets to create a continuous joint along a complete length of each fin crest formed in the thin metal plate or foil by each corrugated fin. The sheets of each plate-fin layer may be thin foil of less than 0.002″ thickness or less than 0.010″ thickness. The foil plates and the corrugated fins may be of similar or dissimilar metals. The number of foil-fin layers may be stacked in the heat exchanger and separated by a spacer, header bar, or gaskets so as to create an adjacent flow path to finned chambers whose walls are defined by outside faces of two adjacent bonded plate-fin layers.

In various embodiments individual foil-fin layers may be modular plate-fin units. Each modular plate-fin unit may have sufficient mechanical strength from the welded fin structure to support pressure internally such that adjacent layers in the heat exchanger do not require internal structural members, nor do they need external supporting plates in the laser welded fin-foil regions.

In various embodiments the heat exchangers may include headers attached to inlets and exits of the heat exchanger by gasketing or laser welding. The headers may be constructed of two metal plates with cutouts for insertion of a foil-fin assembly and cutouts for flow passages between adjacent fin layers once stacked. Cutouts may include holes, apertures and other openings that allow for flow passage. The sheets of the foil-fin cores may be laser welded along their perimeters to the headers, and the headers may be sealed at their outer edge seams such that no fluid flow can leak. The headers may be constructed of metal plates butt welded to form a structure with cutouts for the foil-fin assembly and cutouts for flow passages between adjacent fin layers once stacked. In some embodiments, a divider bar may be bonded to a first and second plate-fin layer side-by-side, thus sealing a different mass of fluid within each of the two plates enabling the heat exchanger to operate with additional fluids.

In various embodiments, the corrugated fins may be oriented in the heat exchanger to provide fluid flow configurations through the heat exchanger including one or more of parallel, cross, counter, and 45° angled fluid flow orientations.

Further embodiments include a method of manufacturing a plate-fin type heat exchanger, including using laser welding to attach corrugated fins to thin plates or foil to create a continuous joint along a complete length of each fin crest formed in the thin plates or foil by each corrugated fin. Some embodiments may include applying layers of the heat exchanger formed by constructing spacer bars between the thin plates or foil or by stacking of header bars, which are attached to the thin plates or foil and have a height or gasket material that creates a channel between adjacent thin plates or foil. Some embodiments may include attaching headers to inlets and exits of the heat exchanger by laser welding. Some embodiments may include attaching a manifold assembly, constructed of thin plate, to inlets and exits of the foil-fin core layers by laser welding the thin plates or foil to an inner perimeter of the manifold. In various embodiments, the thin plates or foil, corrugated fins, spacer bars, manifolds, and headers are made of at least two different materials.

Some embodiments may include applying a pressure across the thin plates or foil to create contact between the plates and the corrugated fin creating the fin crests in the thin plates or foil, wherein the pressure is created by a vacuum on a finned chamber side of the plate-fin layer relative to an exposed face of the thin plates or foil. Some embodiments may include locating the fin crests formed in the thin plates or foil prior to laser welding by mapping locations of the fin crests by: (1) mapping the corrugations with a profilometer scanning in the direction normal to the fins, (2) shining a light onto the surface of the foil or plate and imaging the reflectivity to determine the fin crest locations, or (3) heating the fins and imaging the surface of the foil with an thermal camera to identify the contact points, and using the map of locations of the fin crests or contacting areas to control the laser so that laser welding can be performed at high speeds. Some embodiments may include the laser welding is performed at high speed using the location of fin crests and a laser beam control system comprising one of a dual high speed galvo tilt mirrors or high speed motorized staging, to steer the laser beam along the fin crests while creating weld joints.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is an exploded view of a conventional plate-fin heat exchanger.

FIG. 2 is an isometric drawing of a conventional cross flow plate-fin heat exchanger showing fins in every adjacent layer and the fluid flow paths.

FIG. 3 is a cross section view of prior art, showing a laser welded plate fin structure using pattern welding of sheet pairs, and then expanded under pressure.

FIG. 4 is a cross sectional view of a foil-fin heat exchanger modular foil and fin laser welded base unit according to an embodiment.

FIG. 5 is an isometric view of a foil-fin heat exchanger modular foil and fin laser welded base unit according to an embodiment.

FIG. 6 is an isometric view of a foil-fin modular plate with header according to an embodiment.

FIG. 7A is an isometric close up view of a foil-fin modular plate header according to an embodiment.

FIG. 7B is an exploded view of a foil-fin modular plate header according to an embodiment.

FIG. 8A is an isometric drawing of a foil-fin heat exchanger showing bonded foil-fin layers with headers, stacked to create alternating (un-finned) channel layers according to an embodiment.

FIG. 8B is an exploded drawing of a foil-fin heat exchanger showing bonded foil-fin layers with headers, stacked to create alternating (un-finned) channel layers according to an embodiment.

FIG. 9 is an isometric drawing of a stacked foil-fin heat exchanger and fin layer headers, labeled with fluid flow pass through in the un-finned layers according to an embodiment.

FIG. 10 is a view of a foil fin heat exchanger showing the un-finned fluid paths according to an embodiment.

FIG. 11 is a view of a foil-fin heat exchanger structure that utilizes a 45 degree flow orientation between two fluids.

FIG. 12 is an isometric drawing of a foil-fin heat exchanger structure internally pressurized according to an embodiment.

FIG. 13 is a cross-sectional view of fins that are pressed together to increase the fin density and strength of the foil-fin structure.

FIG. 14A is an isometric view of a stacked foil-fin heat exchanger with an external manifold and tension tie-bar according to an embodiment.

FIG. 14B is an isometric view with cutout showing details of a stacked foil-fin heat exchanger external manifold and tension tie-bar according to an embodiment.

FIG. 14C is an exploded view of a stacked foil-fin heat exchanger external manifold and tension tie-bar according to an embodiment.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Compact high efficiency heat exchangers exist in two categories; Plate-frame, and plate-fin heat exchangers. Plate-frame heat exchangers are constructed of multiple thin plates, often dimpled or shaped, that are slightly separated and held together by compression and gasketing, brazing or welding of the outer seams, or some combination of these methods. Cold and warm fluids pass through alternating chambers created by the plates to transfer heat. The plates usually include undulations in a herring bone pattern consisting of many short fluid paths with frequent change of direction. These heat exchangers have several operational advantages (e.g., mechanical replacement and cleaning of plates) and provide increased surface area per volume compared to shell and tube type heat exchangers.

Plate-fin heat exchangers provide efficient heat transfer between two or more fluids and are more compact than plate-frame heat exchangers. Plate-fin heat exchangers use plates and finned chambers to transfer heat between fluids. The plates and fins are layered to separate hot and cold streams. The fins serve to increase the heat transfer area and increase the structural integrity of the heat exchanger. Plate-fin heat exchangers are currently used in many industries, including natural gas liquefaction, cryogenic air separation, ammonia production, offshore processing and Syngas production.

Conventional plate-fin heat exchangers are arranged by adjacent layers of corrugated fins separated by sheets of metal. Conventional plate-fin heat exchangers are oven brazed, welded or soldered between fin crests and flat metal sheets and at the seams.

Limitations of oven brazed plate-fin heat exchangers include the manufacturing costs (energy inputs for brazing), scalability (size and lifting capacity constraints on vacuum ovens used in manufacturing process), and the non-applicability for brine and seawater processes due to pitting and corrosion when using aluminum and steel based alloys. Whether welded or brazed, a compression may be applied to the plates during manufacturing, and thus, fins or some form of structural members are required within each layer to support the thin walls separating each layer. In brazed heat exchangers, the technical challenges of brazing dissimilar metals makes the use of dissimilar foil and fin material cost prohibitive for most applications. For corrosive operating conditions this often means use of exotic and costly metals throughout the structure, such as titanium, even if one or more fluids are not corrosive.

Laser welding has been used in heat exchanger manufacture. Lasers can apply considerable amounts of high energy in short time intervals, which allows higher manufacturing speed with improved accuracy and repeatability compared to other welding techniques. Laser welding has been used to create patterned bonds between metal sheets that are then deformed under pressure to form longitudinal passages or manifold channels. This type of heat exchanger relies on deformation of the metal in order for the welded metal sheets to unfold, or stretch, upon pressurization into a heat exchange structure with flow channels.

Laser welding has been used to perform controlled depth welding between metal layers (usually 2 layers) in a multi-layer sheet structure. In such conventional methods, selected areas of the sheet stack are welded in a predetermined pattern across the surface, and finally outer sheets are joined to this stack. Then the sheets are expanded, and through superplastic deformation or unfolding action, the desired heat exchanger structure with the patterned welds cause an internal fin structure to be created between the sheets. Heat exchangers formed with this method of hydroforming, or plastic deformation, have notable challenges for production, including the difficulty controlling width dimensions as the part inflates and practical challenges in connecting the inflated parts to headers or manifolds.

Forward conduction laser welding has been proposed for micro-channel heat exchanger construction for bonding stacked sheet materials that could be made of a variety of metal or polymer materials. Forward conduction laser welding involves forming a bond by directing laser energy to an upper sheet that is opaque to the laser and conducts heat to the sheet below. Once bonds are created between multiple sheet pairs, the structure so created is expanded and the resulting deformation creates channels and manifolds for transmission of heat transfer fluid streams.

Conventional methods for manufacturing plate-fin heat exchangers do not include laser-welded heat exchangers in which the core layers contain thin foil that is welded along the length of arbitrarily shaped serpentine fins while in their final geometric state. Further, conventional plate-fin heat exchangers fabricated using very thin foils and laser welding rely on metal deformation and the use of an unfolding and/or stretching action of the metal upon pressurization.

The various embodiments provide a low-cost compact heat exchanger and methods for making the same may be used for heat exchange between corrosive and non-corrosive fluids and that can be configured for a range of operating conditions, most notably for marine applications such as Ocean Thermal Energy Conversion (OTEC) systems. A foil-fin heat exchanger of the various embodiments includes stacked modular core layers in which each core layer includes two planar very thin metal foil sheets with a sandwiched serpentine foil-fin structure. The planar foil sheets and serpentine fins may be bonded together by laser welding along the entirety of each individual fin crest. The core foil fin layers may be laser welded or otherwise sealed at the outer edges to a manifold. A foil-fin heat exchanger manufactured in this manner features modular foil-fin core layers that may be completely independent, in which the bond between the outer foil and inner fin structure constrains the internal flow passage, allowing for the internal space to be internally or externally pressurized. The foil-fin core layers may be stacked to form the heat exchange structure, and may be stacked in such an arrangement as to create a space between the modular foil fin layers for adjacent channel flow (i.e., an un-finned flow path as an alternating fluid layer). The un-finned flow channel may be introduced into the structure by using a spacer bar between the layers, a header bar, a gasket, or other. Each foil fin layer may be constructed of dissimilar metals, such as Titanium foil and Aluminum fins, for example.

The manifold may be constructed of a thin plate, with top and bottom faces providing cutouts for the foil-fin assembly, and side faces and seams sealed to provide flow restriction and structural strength. Foil sheets making up the top and bottom sheets of the core foil-fin layer may be laser welded at their edges around the internal perimeter of a center opening in the manifold, thereby creating a leak-free seal capable of transferring foil tension and shear to the manifold structure. A series of smaller openings may also be located along two parallel outer edges of the manifold, and configured to act as fluid passages between finned layers once stacked. The faces of the manifold may be used as a sealing surface, such that a gasket may be placed between layers to create a seal, while the resultant gap between adjacent core layers also creates the internal channel for another heat exchange fluid, allowing for an integrated heat exchange and manifold structure. The gasket material may be applied to the top and bottom of a metal substrate, which serves as the structural member. The thickness of this metal layer may be adjusted to allow for different fluid channel widths.

A pressure force may be applied to the foil sheets during the welding process to maintain close contact between the foil sheet and the fin crests. The application of pressure increases the contact area between the foil sheet and the fins, thereby increasing the weld area and improving the heat transfer ability of the heat exchanger. The foil sheets may be flat or may be corrugated to match the fins. Corrugation in the sheets may be formed by the fins as a result of the pressure or vacuum applied to them. The described process results in a welded connection of the fin crests to the foil sheets along the entirety of the fin length and along each individual fin, and which is capable of taking shear and tension forces between the foil and fins, and efficiently transferring heat.

Applying a pressure differential across the foil during the welding process provides contact between the metal surfaces and maps the fin-crests to the laser weld guidance software. Without close contact, the laser weld may burn through the foil layer. It has been demonstrated that a very high pressure, such as up to 80% of the buckling strength of the fins, may be applied to the top and bottom surfaces of the foil-fin structure prior to welding in order to permanently stretch the foil around the crest of the fins. The resulting corrugations are much higher after this process, creating larger contact areas and better accuracy of fin registration.

A very uniform and reliable pressure differential may be obtained in some embodiments by creating a vacuum on the fin side of the sheet, thus creating a pressure differential due to the atmospheric pressure on the exposed (un-finned) side of the sheet. This embodiment method has been tested and shown to produce reliable and consistent contact between the foil and fins.

Prior to welding the foil to fins, the foil may be welded to the edges of the pre-fabricated manifold. This edge welding seals the structure and controls the deformation otherwise caused by introduction of tension and shear on the foil-fin assembly during the fin weld process.

Once under vacuum, the fin crests create corrugations in the foil sheet. Locations of the fin crests may be determined by a profilometer scan in a direction normal to the fins, or may be determined precisely by imaging the optical properties of the foil-fin corrugations and processing the optical patterns in order to map the fin crests for use by the laser control software.

Core layers consisting of the laser-welded foil-fins and a sealed manifold may be stacked to form the heat exchanger with adjacent flow conduits.

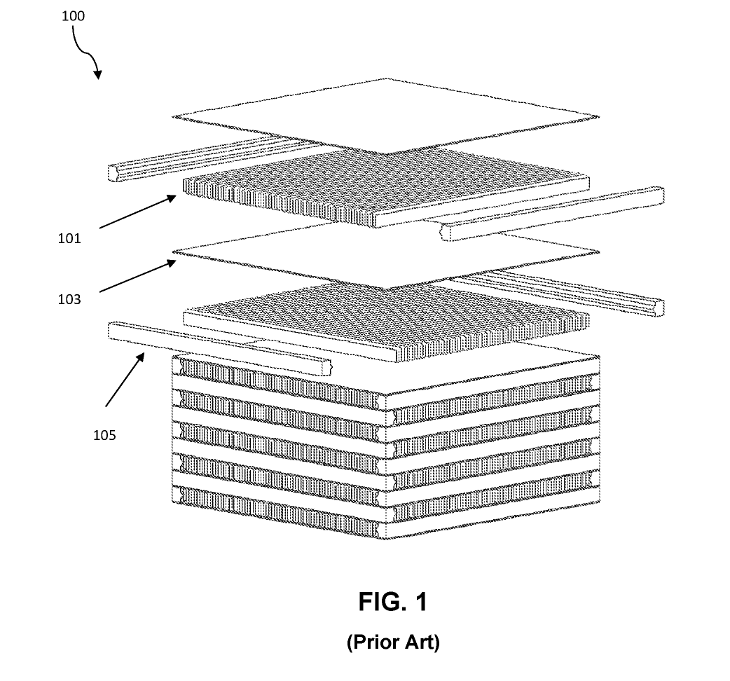

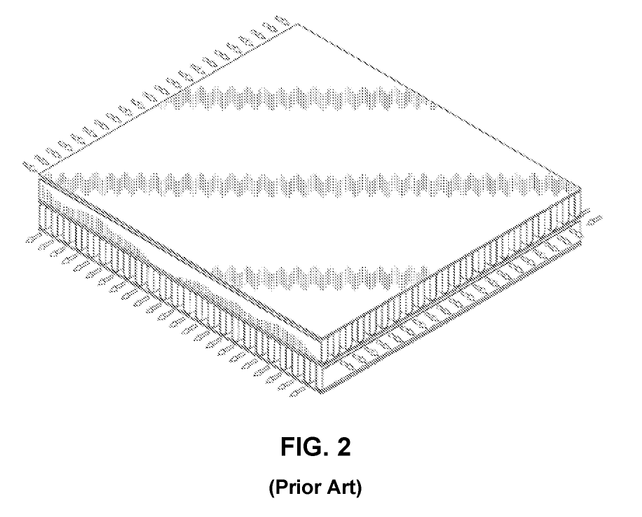

Referring now to the drawings, FIG. 1 illustrates a conventional plate-fin heat exchanger 100 in which serpentine fins 101 are layered between thin sheets 103, and in which the edges of each layer are sealed with a thick header or leading edge bar 105. The longitudinal fin directions in each layer are at 90 degrees to the adjacent layers. In conventional manufacturing processes, the entire structure, once assembled, is placed into an oven for brazing. The sheets and fins are placed in compression during brazing for intimate contact, and thus, each adjacent layer must contain a fin or other similar member for structural strength. FIG. 2 shows such conventional heat exchanger indicating the flow paths in a conventional plate-fin assembly.

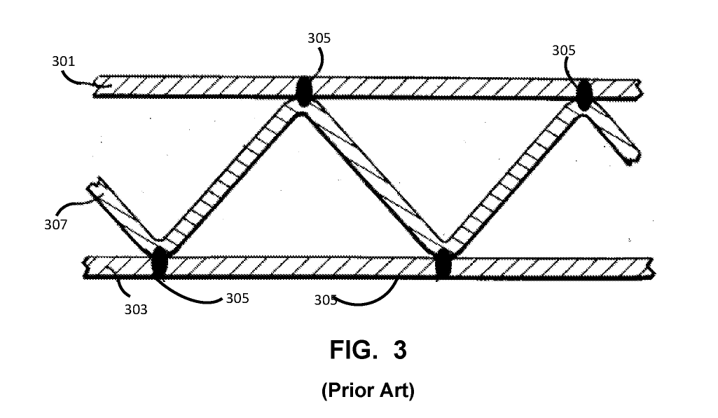

FIG. 3 shows a detail of a prior art heat exchanger in which a three-sheet sandwich structure 300 is welded and expanded using a hydroforming pressurization process. The top sheet 301 and bottom sheet 303 are welded at points 305 to the core sheet 307 while in a flat geometric configuration. The assembly is then pressurized and expanded to form the flow channels. The shape of the fins is thus determined by the pressurization and plasticity of the material. The fin structure forms a tensioned triangular truss. This structure and construction method has practical limitations related to how it is connected to a manifold and the ability to construct a serpentine style plate-fin heat exchanger with a high concentration of fins per square inch, as well as other customizations of fin geometries.

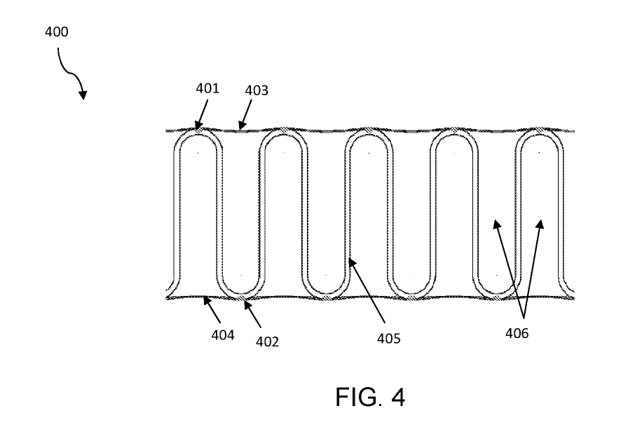

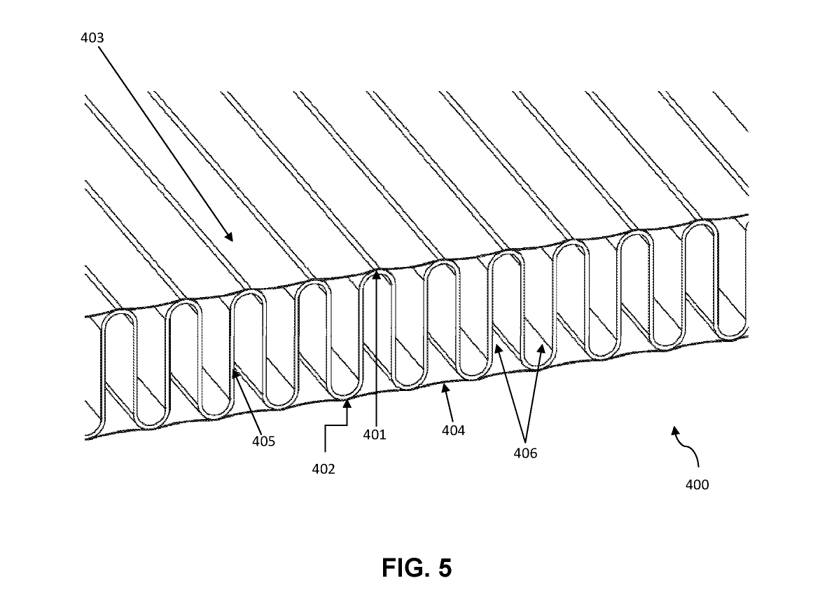

FIG. 4. and FIG. 5 illustrate a core modular foil-fin layer 400 (excluding the manifold) according to various embodiments. The base unit of the heat exchanger may include fins that are laser-welded along their crests on the top 401 and bottom 402 to two sheets 403, 404 using laser lap welding. The fins 405 may be sandwiched between the foil sheets 403, 404, and a vacuum may be applied to the finned channels 406 during welding such that the foil sheets deform to the curves of the fin crests, creating corrugations. Intimate contact between the fins and foil may be created at the fin crests and along the longitudinal length of the fins. In this embodiment, the foil sheets 403, 404 may be constructed of titanium and the fins 405 may be constructed of aluminum. Care and tight control tolerances should be used to acquire proper alignment and heating of the weld zones.

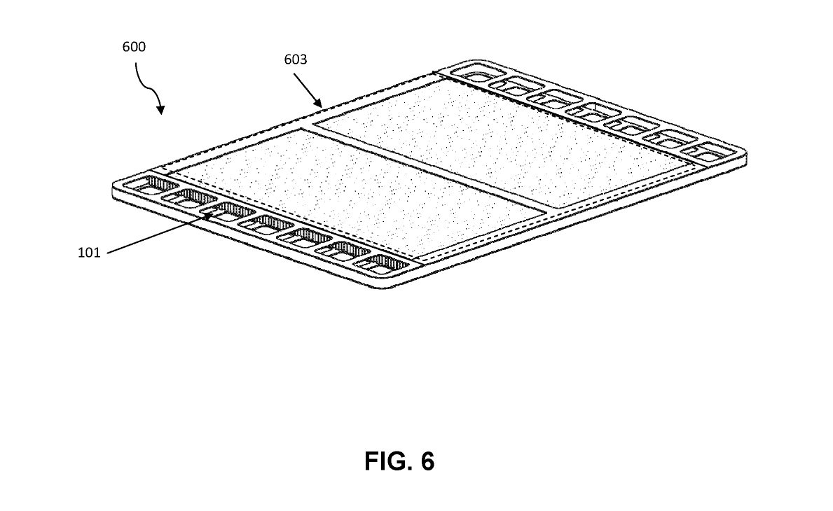

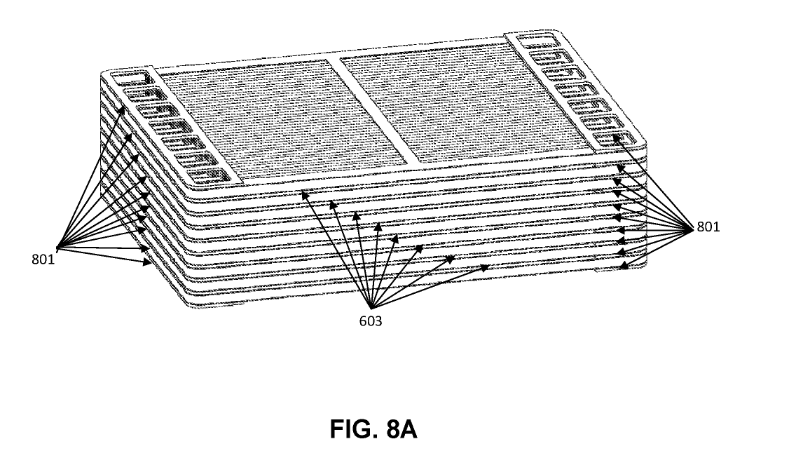

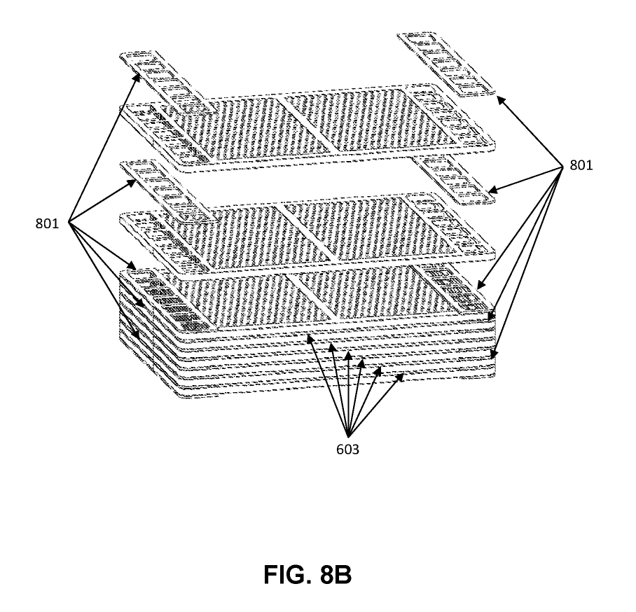

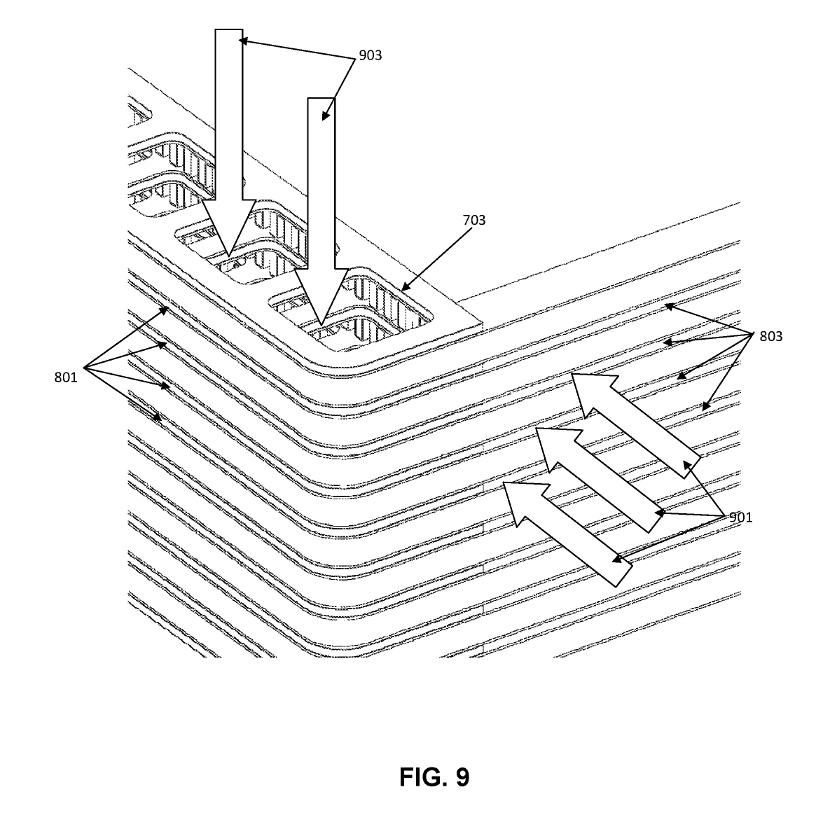

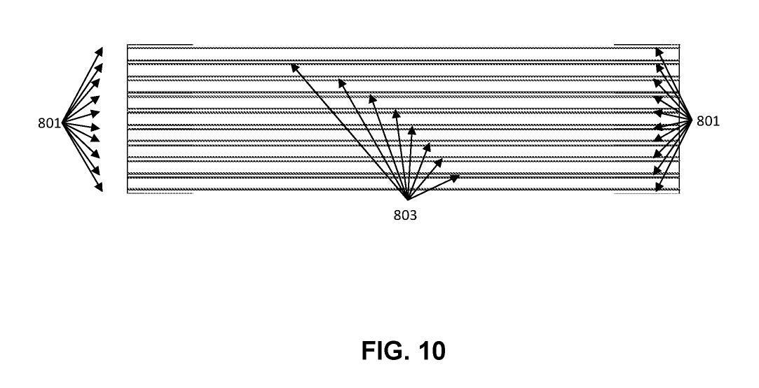

FIG. 6 illustrates a core foil-fin unit assembled with an embodiment manifold 600 to form a unit 600 that may be stacked with other such units to form an assembly. Such units 600 may be stacked such that alternating layers within the heat exchanger are created that include channels 603 without fins 405, extruded members, or other structural forms. A diagram of multiple stacked layers is shown in FIG. 8A, FIG. 8B and FIG. 9, and FIG.10. A full plate-fin heat exchanger would be made up of many of these layers. Each layer may be relatively thin compared to the layer's length and width dimensions.

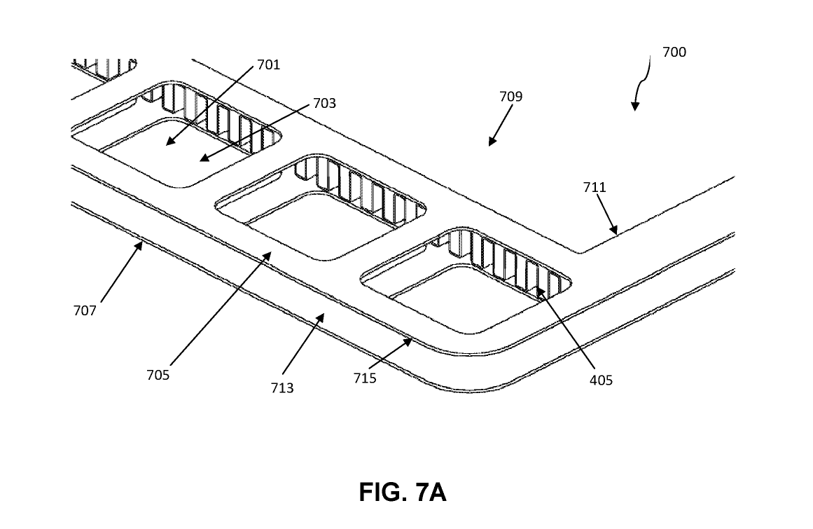

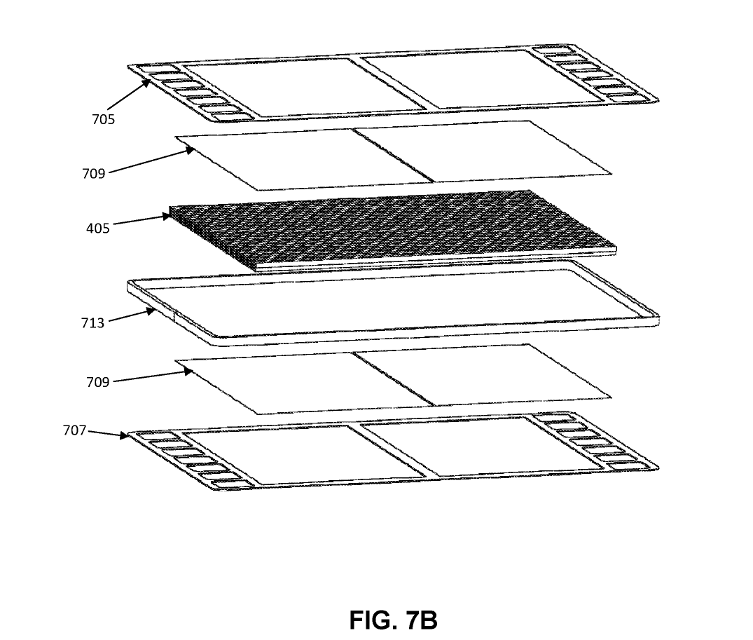

FIG. 7A shows an embodiment of a manifold that may be used in each of the core layers. FIG. 7b shows an exploded view of a foil-fin module with embodiment manifold.

The embodiment manifold illustrated in FIGS. 7A and 7B may be an assembled thin plate structure 700 with openings 701 for the foil-fin core and openings 703 for fluid passages between layers. A foil sheet 709 is shown laser welded to the top manifold plate 705 along the path 711. A second foil sheet 709 is shown laser welded to the bottom manifold plate 707 along the path 711 to form seam welds to the inside surfaces of the manifold.

The fin layer may be inserted between the foil and manifold assemblies along with the edge frame 713, as shown in FIG. 7C. The top manifold plate 705 and bottom manifold plates 707 may be welded to the edge frame 713 to form the outermost seam welds 715. The foil 709 may then be laser welded to the fin crests. The perimeter laser welds 711 between the foil and manifold plates seal the fluid passages and also transfer tension and shear forces from the foil to the more structurally rigid manifolds.

The faces of the resulting manifold surfaces may be used to seal adjacent core layers when the core layers are stacked into a heat exchanger assembly as shown in FIG. 8A and FIG. 8B. A gasket spacer 801 may be placed between layers at the manifold openings, as shown in FIG. 9, such that the hydraulic diameter of adjacent flow layers 603 created by the stacking of the core foil-fin layers may be determined by gasket dimensions. This embodiment of the core foil-fin layer eliminates the need for a thick leading edge bar, simplifying the fabrication process.

Use of gasket spacers provides several advantages, including easier disassembly of the units if necessary, such as for cleaning Gasket spacers may be of any desire thickness. Different thicknesses allow for exchanging gasket spacers in a heat exchanger with different thickness gasket spacers for the same manifolds. This allows the same manifolds to be used while modifying thermal and/or hydrodynamic characteristics of a particular heat exchanger. For example, different gasket spacer thicknesses may be used to modify flow rates or heat transfer rates, and/or different thicknesses may be used with different fluids. Different levels may have different thickness gasket spacers as well.

The gasket spacers can be made of any suitable material, including metals or polymers.

Alternative embodiments of the manifold may use a header manifold and leading edge bar.

Using a continuous laser lap welding to attach the plates, as opposed to more traditional bonding methods such as brazing, may enable the use of dissimilar materials for the plate and fins with relative ease. The ability to use dissimilar metals is advantageous for plate-fin heat exchangers because dissimilar materials enables expensive corrosion resistant materials to be used only for structures that will be in contact with the corrosive fluids. Using a continuous laser lap welding to attach the plates may also enable structures to be constructed of very thin foils, such as of thicknesses below 0.004″. Foil thickness may be constrained by the operating pressure of the unit, material strength, and the attachment gap between adjacent fin crests, and may be adjusted based on the heat exchanger's end use. Fin thickness may depend on the pressure rating needed for the heat exchanger, fin density and material strength.

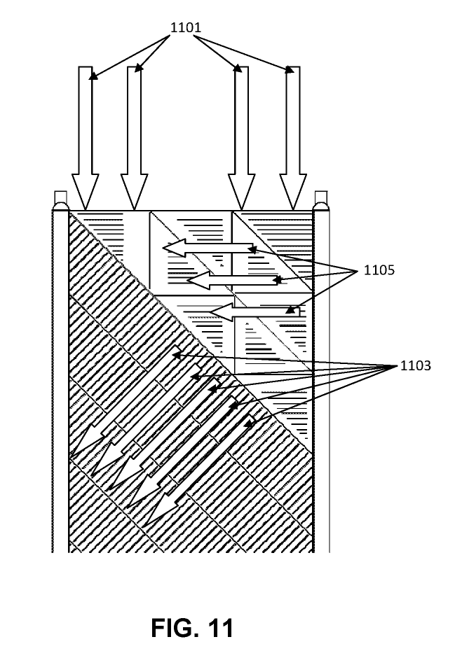

As an example, a notional heat exchanger for Ocean Thermal Energy Conversion applications fabricated according to the various embodiments could use very thin sheets of titanium (˜0.001″ thick) for the plates, while less expensive aluminum could be used for thicker fin material. In such an example heat exchanger, seawater could flow in the area between the titanium sheets (shown as fluid passage A 901 and 1101 in FIGS. 9 and 11, respectively) providing corrosion protection, while a refrigerant, such as ammonia, flows through the aluminum finned passages (shown as Fluid Passage B 903 and 1105 in FIGS. 9 and FIG.11, respectively). The use of very thin titanium sheets may reduce the amount of titanium used in the heat exchanger, thereby keeping costs low.

Using dissimilar metals in a brazed plate-fin structure is possible, but manufacturing is a complicated and expensive process. Conventional brazing of a plate-fin heat exchanger requires the entire heat exchanger to be heated to a very high temperature, typically just below the melting temperature of the base material and just above the melting temperature of the braze material. This process requires a very large furnace and consumes considerable amounts of energy to generate the required heat. Welding with a laser according to the various embodiments, on the other hand, requires significantly less energy during the manufacturing process and does not require heating of the entire plate or fin volumes.

Welding the plate-fins as modular base units enable enhanced designs, such as the alternating fin-channel arrangement shown in FIG. 11. The example plate-fin heat exchanger illustrated in FIG. 11 features a 45 degree cross flow between a first fluid flowing as indicated by 1105 and a second fluid flowing as indicated by 1103 and 1105. This can be expanded to have different fluids flowing at each layer or any combination of fluids if the fluids are directed between each layer. In brazed plate-fin heat exchangers the plate and fins need to be stacked and compressed during manufacturing to ensure intimate contact between plate and fins. Brazing cannot occur without contact. This necessitates structural members in each layer, as shown in FIG. 1 in order to keep the thin layers of metal foil/sheet from bending and separating from adjacent layers. By using laser welding to construct modular units as illustrated in FIG. 8, each layer is bonded fully before being stacked into a core, allowing for adjacent flow paths to have larger hydraulic diameters. Traditional plate-fin heat exchangers are constructed as a single unit once the oven brazing process is complete. In contrast, the foil-fin modular structure may be disassembled for cleaning and re-assembly.

Laser welding requires close contact between the foil sheets and fins, precise laser positioning, and a rapid production method in order to produce the described structure reliably and at low cost. Various embodiments provide a novel method for construction of each plate using laser welding is described below.

Corrugated fins (e.g., 405) may first be sandwiched by two metal foil sheets (e.g., 403, 405). The resulting finned chamber may be put under vacuum in order to push the foil tightly against the fin crests or ridges. The vacuum causes the foil to corrugate around the contours of the fins, creating visible and measurable ridges and valleys. These corrugations, which indicate the locations for laser welding, may be mapped into the laser control software using any means, such as a profilometer or optical processing.

A profilometer may be used to measure the profile of the corrugations by running the scanner normal to the direction of the fins on the top of each foil sheet. The data from the profilometer may be processed and the resultant map of fin crests may be used to precisely specify the locations of weld joints.

Alternatively, an optical process may be used to identify the location of the fin crests, such as by shining light onto the vacuumed foil-fin sheets and locating the changes in reflected light over the corrugation ridges and valleys or by transferring heat into the structure and thermally imaging the heat patterns. These methods are accurate to within a few pixels of optical measurement, which, by focusing an optical camera lens nearby and stitching together images, may be used to create reliable localizations of fin crest weld joint locations well within the tolerances required for a laser weld. The optical localization of fin crests has the significant advantage of rapid and immediate mapping, enabling a low cost manufacturing method for the proposed structure.

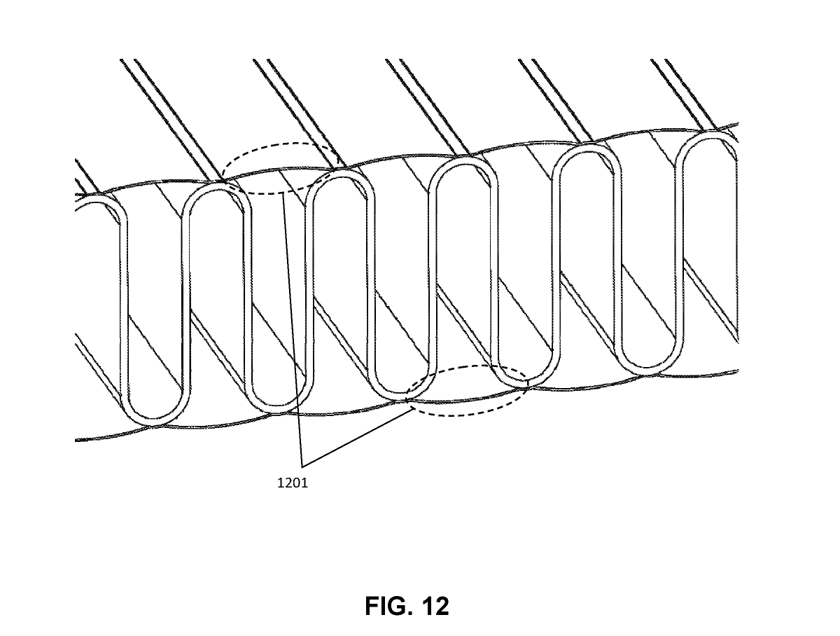

The laser welded foil-fin may be joined while under vacuum to obtain contact between the foil and fin. Thus, if the finned chamber is pressurized during operation, the foil between fin crests may be corrugated outward rather than maintain their original corrugation, as shown in FIG. 12 at 1201. This corrugation also enhances the convective heat transfer properties of the heat exchanger.

The welds may be made by focusing the laser beams along the fin crests with an energy density and dwell time (or rate of advance) controlled to heat and weld the two metals together without burning through the materials. Testing has shown that use of the vacuum assembly and fin-crest localization described herein, combined with methods for rapidly controlled lasers, such as galvo-tilt mirrors or high precision linear stages, may provide rapid and reliable assembly, control, and welding of foil and fin heat exchangers of the various embodiments. Laser parameters may be modified for various foil and fin thicknesses and material selections. For example, use of dissimilar metals, such as titanium foil and aluminum fins, may require that the welds melt the two metals sufficient for mechanical connection, but not so much that the aluminum fin material can diffuse through to the surface of the titanium foil. Laser power, use of continuous versus a pulse frequency, and speed are all critical variables that may be controlled in the welding processes of the various embodiments. Development has shown that a 1 kW laser operating at a notional speed of 2 m/s, and controlled by the above methods, may be used to weld a 0.001″ thick titanium foil sheet to aluminum fins without burning through the titanium or otherwise allowing the aluminum to mix to the titanium foil surface.

Headers

FIGS. 6-9 show various embodiment designs for headers that direct the flow of two fluids through a heat exchanger. Similar header designs are possible for alternative flow orientations, as shown in FIG. 11. Headers may be added to the layers after the layers are stacked. Alternatively, headers may be bonded to individual layers as illustrated in the drawings, after which the layers with attached header may be stacked.

Additionally, spacer bars rather than headers may be used to separate fluid layers. Each base layer may be individually bracketed by headers, and these header-foil-fin-plate base units may then be layered to form the heat exchanger. The space created between the layers thus creates the un-finned chamber layers 603 previously described and illustrated in FIG. 8 and FIG. 9.

A core foil-fin layer formed of serpentine fins sandwiched between two thin layers of foil can hold high pressures without any additional external structural support. This is especially advantageous when compared to conventional plate-frame type heat exchangers, which require thick metal plates on both sides of the heat exchanger plate and which cover the entire area of the plate. In the various embodiments, the only area of the heat exchanger that may require external support is at the manifold openings, where the second fluid B 903 enters and exits, as shown in FIG. 9 at 703.

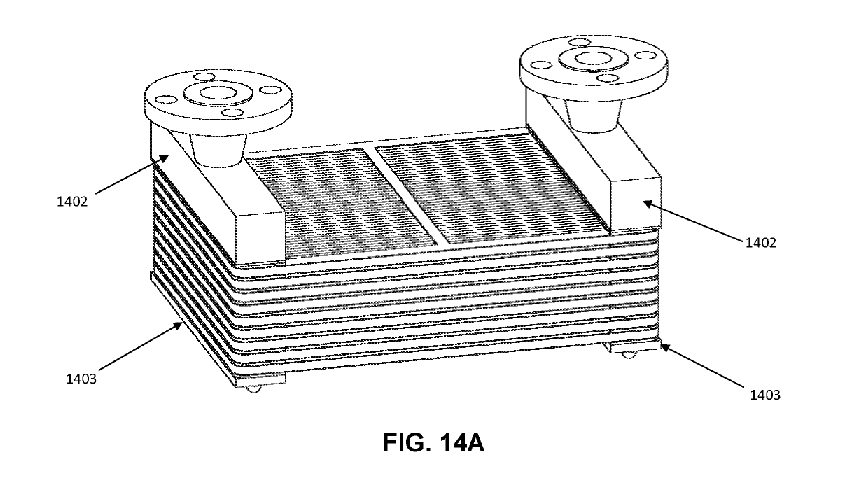

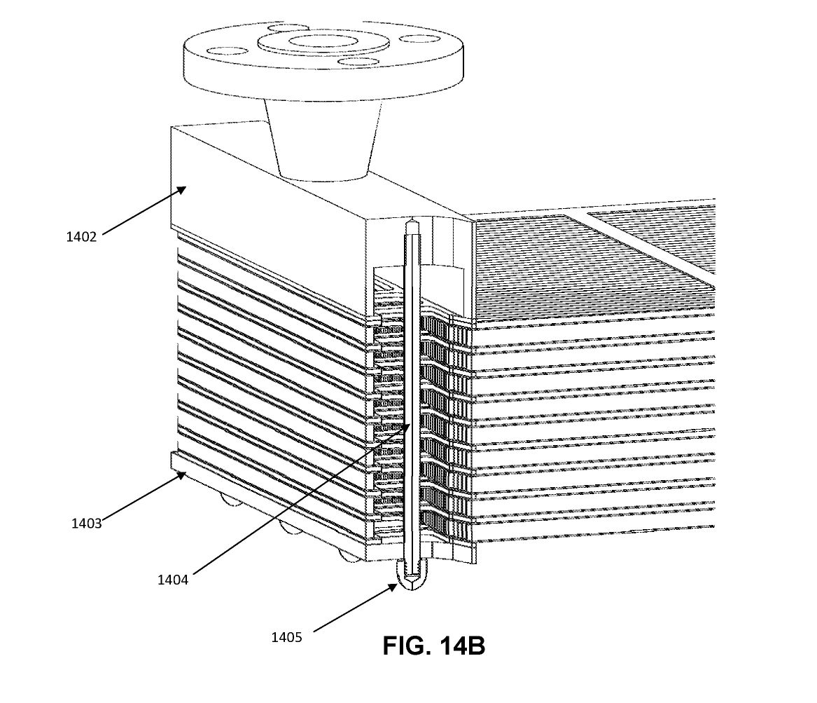

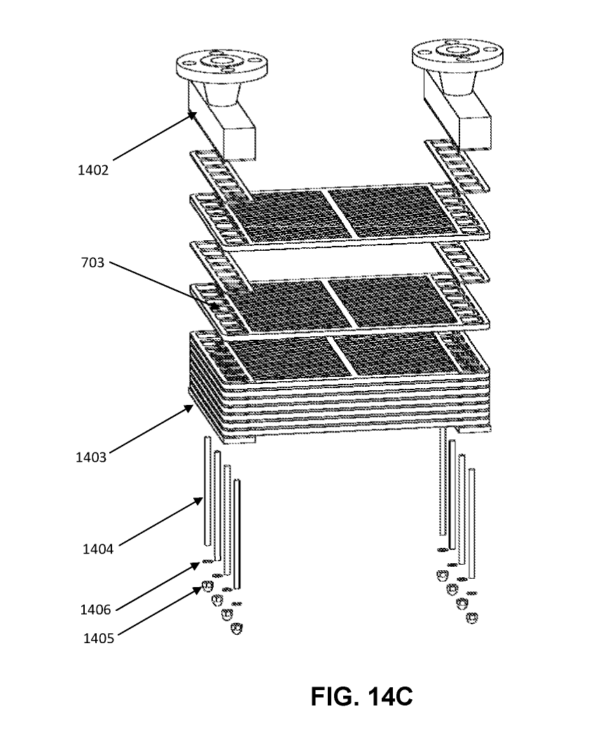

FIGS. 14A, 14B, and 14C illustrate an embodiment in which headers may be used, the headers may be very small compared with dimensions of the plate. This allows for containing the pressure acting upon the headers to be confined to a relatively small area. With reference to FIGS. 14A-14C, the region between fluid B top header 1402 and fluid B bottom header 1403 may be pressurized and therefore may be supported by tie-bars 1404. The top header 1402 and bottom header 1403 must be of sufficient strength and stiffness to resist the internal pressure inside fluid B passage 703. The tie bars 1404 may be joined to the top header 1402 with a threaded or welded connection, and the bottom header 1403 may be connected using a sealing nut 1405 and an o-ring 1406.

An advantage of the various embodiments is the efficiency with which heat is transferred between the two fluids that is achieved in the heat exchanger.

A clamping or suction pressure may be provided on the plates to increase the contact area between the plates and fins, allowing for a larger weld width. If the clamping (suction) pressure is applied uniformly across the surface of the plate, the plate may become corrugated by the fins. The extent of this corrugation may be a function of the fin spacing, plate thickness and clamping pressure. Illustrations of a plate that has been corrugated by fins are shown in FIGS. 4, 5, and 12.

The convective heat transfer coefficient on the plate side may also impact the heat transfer ability of the heat exchanger. Creating corrugations of the plates may cause the fluid on the plate-side to be more turbulent, which increases the convective heat transfer coefficient. The laser welding of the foil-fin assembly is performed while under vacuum to obtain/maintain contact between the foil and fin. Once the finned chamber is pressurized during operation the foil between fin crests may be corrugated outward, as shown in FIG. 12 at 1201.

The spacing of the gasket spacers or fluids that pass between the spaces can also be used to modify the heat transfer ability of the system.

Many plate-fin heat exchange applications operate at elevated pressures. For example, in order for the foil-fin heat exchanger to be applicable for Ocean Thermal Energy Conversion use, the fin side should be capable of withstanding the pressure of ammonia at about 30° C. (which is 1170 kPa). The foil-fin bond/weld of the various embodiments is of sufficient strength to withstand this elevated pressure. Other embodiments of this invention may withstand higher or lower pressures.

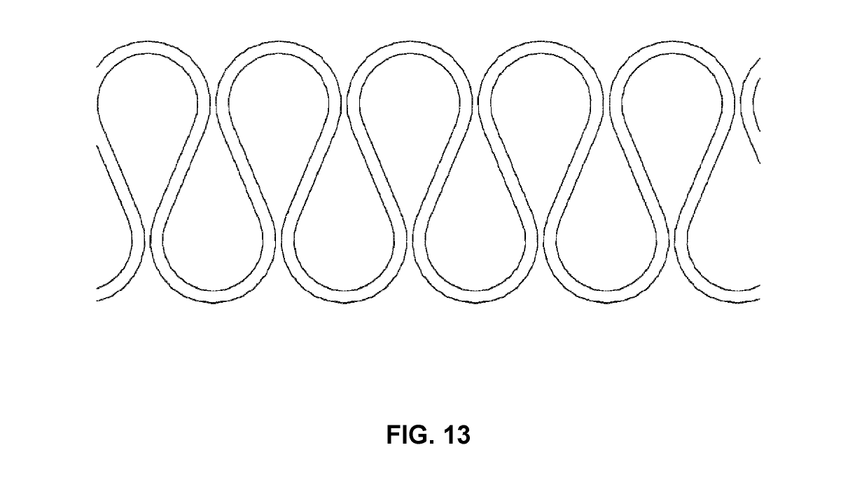

Alternative fin shapes have also been considered in order to improve the pressure holding capability of the fins. Square-top fins, zigzag or ‘herringbone’ fins, and other fin shapes may also be used in various embodiments. FIG. 13 illustrates one such fin shape according to an embodiment. The fin shape illustrated in FIG. 13 may be created by compressing serpentine fins from the edges prior to inclusion in the foil-fin heat exchanger core.

The various embodiments may be configured to encompass any of the possible flow orientations, including cross flow, counter flow and parallel flow. In an embodiment illustrated in FIG. 11 under consideration for a notional OTEC condenser, the cold water flows vertically as indicated by 1101 and ammonia flows at a 45° angle as indicated by 1103. This particular orientation may be beneficial because the fluid flow orientations enable a long slender heat exchanger (desirable for space efficiency) while reducing the flow length of each ammonia flow passage. Reducing the length of the ammonia flow passages may be beneficial to the heat transfer efficiency because it may reduce the average film thickness of the condensed ammonia. The modular assembly of the foil-fin layers enables flow paths for various configurations and working fluids.

The preceding description of the disclosed embodiments is provided to enable any person skilled in the art to make or use the various embodiments. Various modifications to these embodiments will be readily apparent to those skilled in the art, and the generic principles defined herein may be applied to other embodiments without departing from the spirit or scope of the invention. Thus, the claims are not intended to be limited to the embodiments shown herein but are to be accorded the widest scope consistent with the following claims and the principles and novel features disclosed herein.

What is claimed is:

1. A heat-exchanger comprising:
a plate-fin type heat exchanger constructed from a number of foil-fin layers.

2. The heat-exchanger of claim 1, wherein the foil-fin layers are constructed of corrugated fins sandwiched between two sheets of thin metal plate or foil, and wherein the corrugated fins are laser welded to the metal sheets to create a continuous joint along a complete length of each fin crest formed in the thin metal plate or foil by each corrugated fin.

3. The heat-exchanger of claim 1, wherein the sheets of each plate-fin layer are thin foil of less than 0.002″ thickness.

4. The heat-exchanger of claim 1, wherein the sheets of each plate-fin layer are thin foil of less than 0.010″ thickness.

5. The heat-exchanger of claim 1, wherein the foil plates and the corrugated fins are of dissimilar metals.

6. The heat-exchanger of claim 1, wherein the number of foil-fin layers are stacked in the heat exchanger and separated by one or more of a spacer, header bar, or gasket creating an adjacent flow path to finned chambers whose walls are defined by outside faces of two adjacent bonded plate-fin layers.

7. The heat-exchanger of one of claims 2, wherein the individual foil-fin layers are modular plate-fin units, each modular plate-fin unit has sufficient mechanical strength from the welded fin structure to support pressure internally such that adjacent layers in the heat exchanger do not require internal structural members.

8. The heat-exchanger of claim 1, further comprising headers attached to inlets and exits of the heat exchanger by gasketing or laser welding.

9. The heat exchanger of claim 8, wherein the headers are constructed of two metal plates with cutouts for insertion of a foil-fin assembly and cutouts for flow passages between adjacent fin layers once stacked, and wherein the sheets of the foil-fin cores are laser welded along their perimeters to the headers, and wherein the headers are sealed at their outer edge seams such that no fluid flow can leak.

10. The heat exchanger of claim 1, wherein the corrugated fins are oriented in the heat exchanger to provide fluid flow configurations through the heat exchanger comprising one or more of parallel, cross, counter, and 45° angled fluid flow orientations.

11. The heat exchanger of claim 1, wherein a divider bar is bonded to a first and second plate-fin layer side-by-side, thus sealing a different mass of fluid within each of the two plates enabling the heat exchanger to operate with additional fluids.

12. A method of manufacturing a plate-fin type heat exchanger, comprising using laser welding to attach corrugated fins to thin plates or foil to create a continuous joint along a complete length of each fin crest formed in the thin plates or foil by each corrugated fin.

13. The method of manufacturing a plate-fin type heat exchanger of claim 12, further comprising applying layers of the heat exchanger formed by welding spacer bars between the thin plates or foil, or by stacking of header bars that are attached to the thin plates or foil and have a height or gasket material that creates a channel between adjacent thin plates or foil.

14. The method of manufacturing a plate-fin type heat exchanger of claim 13, further comprising attaching headers to inlets and exits of the heat exchanger by laser welding.

15. The method of manufacturing a plate-fin type heat exchanger of claim 14, further comprising attaching a manifold assembly, constructed of a thin plate, to inlets and exits of the foil-fin core layers by laser welding the thin plates or foil to an inner perimeter of the manifold.

16. The method of manufacturing a plate-fin type heat exchanger of claim 15, wherein the thin plates or foil, corrugated fins, spacer bars, manifolds, and headers are made of at least two different materials.

17. The method of manufacturing a plate-fin type heat exchanger of claim 12, further comprising applying pressure across the thin plates or foil to create contact between the plates and the corrugated fin creating the fin crests in the thin plates or foil, wherein the pressure is created by a vacuum on a finned chamber side of the plate-fin layer relative to an exposed face of the thin plates or foil.

18. The method of manufacturing a plate-fin type heat exchanger of claim 17, further comprising locating the fin crests formed in the thin plates or foil prior to laser welding by mapping locations of the fin crests by either (1) mapping the corrugations with a profilometer scanning in the direction normal to the fins or (2) shining a light onto the surface of the foil or plate and imaging the reflectivity to determine the fin crest locations, and wherein the map of locations of the fin crests is used to control the laser so that laser welding can be performed at high speeds.

19. The method of manufacturing a plate-fin type heat exchanger of claim 12, wherein the laser welding is performed at high speed using the location of fin crests and a laser beam control system comprising one of a dual high speed galvo tilt mirrors or a high speed motorized staging, to steer the laser beam along the fin crests while creating weld joints.
